(19) United States
(12) Patent Application Publication
(10) Pub. No.: US 2025/0290264 A1
(43) Pub. Date: Sep. 18, 2025

(54) LOCKING RELEASE MECHANISMS FOR ROTARY DRIVERS AND RELATED SYSTEMS

(71) Applicant: Ojjo, Inc., San Rafael, CA (US)

(72) Inventor: Oleg Nashelskiy, Carson City, NV (US)

(21) Appl. No.: 19/076,754

(22) Filed: Mar. 11, 2025

Related U.S. Application Data
(60) Provisional application No. 63/564,227, filed on Mar. 12, 2024.

(51) Int. Cl. E02D 7/22

(52) U.S. Cl. CPC E02D 7/22

(57) ABSTRACT

Disclosed is a chuck for a rotary driver having a main body, a flange at a first end of the main body, a receiving portion at a second end and having repeating indentations dimensioned to receive a driving ring of a foundation component, and a pair of opposing pawls extending into the receiving portion at first ends that are displaced when a foundation component is loaded into the receiving portion. The pawls resist displacement with a first force when a foundation component is loaded and with a second force when a foundation component is removed. The chuck may also include a release mechanism having levers that move a second end of opposing pawls to release the foundation component when one of the levers of the pair is compressed towards the flange.

### RELATED APPLICATION

This application claims priority to U.S. Provisional Patent Application No. 63/564,227 filed on Mar. 12, 2024, the contents of which are hereby incorporated by reference.

### BACKGROUND

The applicant of this invention has developed a proprietary foundation system for supporting single-axis trackers and other structures known commercially as EARTH TRUSS. The EARTH TRUSS foundation is constructed from a pair of driven in-ground foundation components, a truss apex component known as a truss cap or truss adapter, and a pair of upper leg portions that interconnect the truss cap to the in-ground components to unify the truss. In some cases, the in-ground components, known commercially as screw anchors, may be driven at angles relative to plumb to make an A-frame-shaped truss that extends all the way into the ground. In other cases, the below-ground anchors may be driven at a plumb orientation, with elbow adapters above ground that form, the A-frame shaped connection to the truss cap. The latter configuration may be useful, for example, in reactive soils such as certain clays and soils that are prone to frost heave. These reactive soils may require anchors that are driven deeper than the embedment depths required in ordinary soils and may also require that they be driven plumb rather than at angles to reduce any surface area in the direction of soil movement. As a result, the anchors may be larger in diameter, thicker walled, longer in length, and greater in mass.

The applicant has also developed a machine for installing its screw anchor foundation components and assembling corresponding truss foundations. Known commercially as a TRUSS DRIVER, this machine is characterized by a tracked chassis with a large, articulating mast having a rotary driver and hydraulic drilling tool oriented on the same axis so that as the rotary driver embeds the screw anchor, the hydraulic drilling tool may operate a drill rod through the rotary driver and out of the lower open of the drilling tool to provide real-time drill assist. Computer control of the machine enables components to be embedded and trusses to be installed quickly and accurately.

Loading larger and heavier screw anchors into the chuck of rotary driver of the TRUSS DRIVER machine may require some modification to the chuck. Anchors are loaded by picking them up and pushing them up into the chuck, however, the chuck needs to be able to hold the anchor with greater resistance than that required to load them to keep them attached up to and during the embedment operation. Typically, after a screw is embedded, the rotary driver is simply retracked up the machine mast for the next embedment operation. Even if the holding power of the chuck to the screw anchor is several hundred pounds, which is the force required to separate the screw anchor from the chuck, the hydraulic motor pulling the rotary up can easily overcome that force. However, in some cases, it may be necessary to remove an anchor from the chuck before driving it. For example, if the wrong length anchor is loaded to the machine and needs to be swapped out for the correct one. Or, if it is discovered after loading that the screw is damaged and needs to be replaced with a normal one. Or, during testing, it is common to drive and un-drive screw anchors before moving to the next test location. In all these cases, it is necessary to remove the screw from the chuck, however, doing so requires a substantial amount of downward pulling force, in some cases, in excess of three hundred pounds. Therefore, various embodiments of the present invention provide a chuck for a rotary anchor that enables an anchor to be loaded with relatively low force, holds the anchor with a far greater amount of force, and yet can release the anchor with a relative low force if required. These and other features and advantages will be made clear from the following description with reference to the drawing figures.

### SUMMARY

In general, this disclosure relates to systems, devices, and methods for installing screw anchor foundation components and assembling corresponding truss foundations. Some embodiments of such a machine may be characterized by a tracked chassis with a large, articulating mast having a rotary driver and hydraulic drilling tool oriented on the same axis so that as the rotary driver embeds the screw anchor, the hydraulic drilling tool may operate a drill rod through the rotary driver and out of the lower open of the drilling tool to provide real-time drill assist. In some embodiments, computer control of the machine enables components to be embedded and trusses to be installed quickly and accurately.

Techniques and machines described herein may improve the ease and accuracy of driving foundation components into all kinds of soils. For example, a device that performs the installation described herein

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a side view of a chuck with a release mechanism according to an embodiment of the present disclosure.

FIG. 2 is another side view of a chuck with a release mechanism according to an embodiment of the present disclosure.

FIG. 3 is a bottom view of a chuck with a release mechanism according to an embodiment of the present disclosure.

FIG. 4 is an exploded view of a chuck with a release mechanism according to an embodiment of the present disclosure.

FIG. 5 is a side view of a locking release mechanism according to an embodiment of the present disclosure.

FIG. 6 is another side view of a locking release mechanism according to an embodiment of the present disclosure.

FIG. 7 is yet another side view of a locking release mechanism according to an embodiment of the present disclosure.

FIG. 8 is another further side view of a locking release mechanism according to an embodiment of the present disclosure.

FIG. 9 is a view of a foundation component according to an embodiment of the present disclosure.

### DESCRIPTION

The following description is intended to convey a thorough understanding of the embodiments described by providing specific embodiments and details involving chucks for hydraulically powered rotary drivers. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

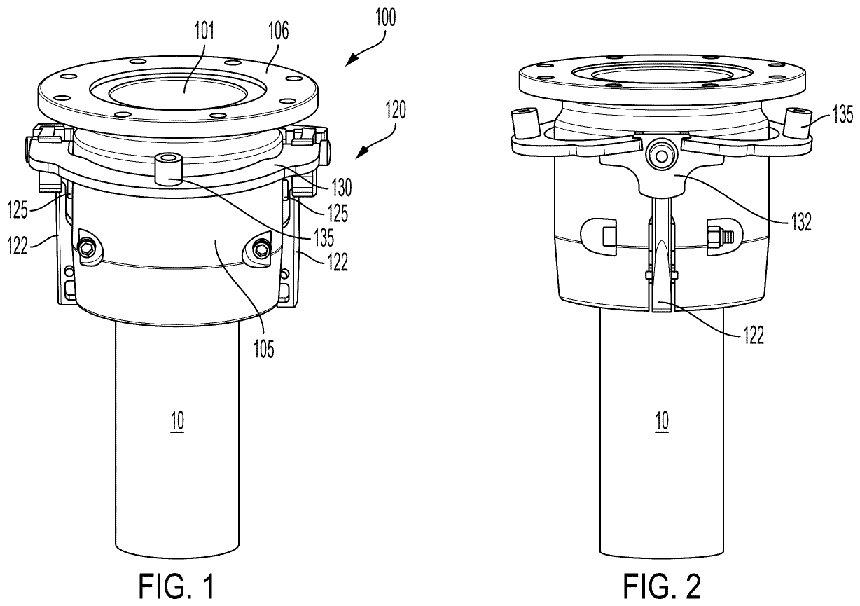

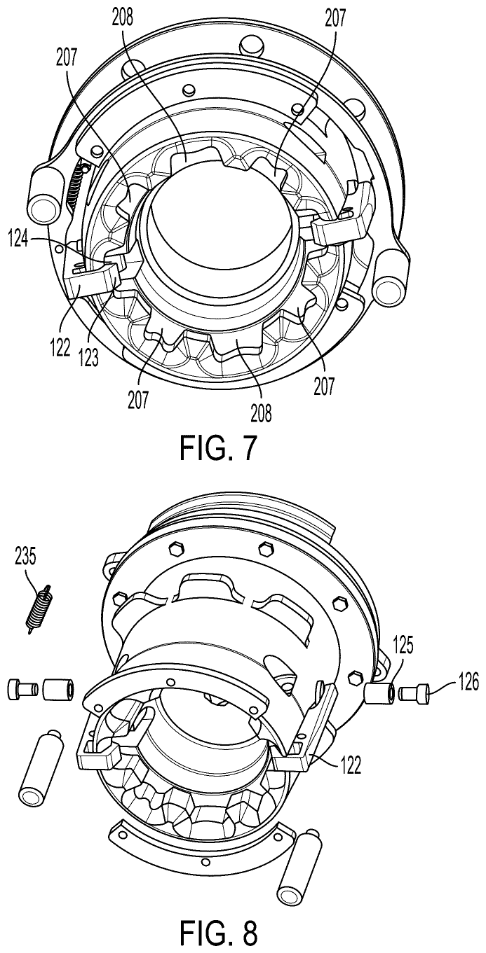

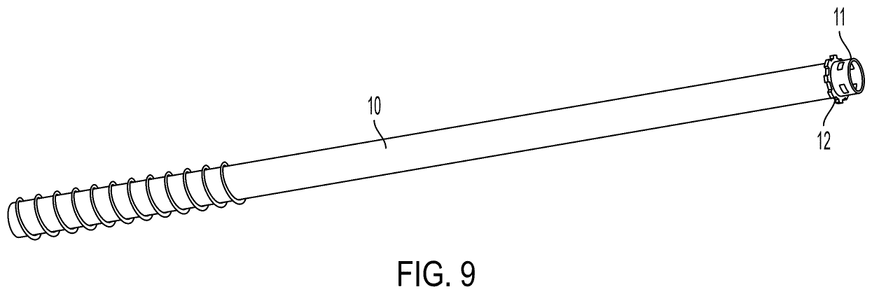

Starting with FIG. 9, this figure shows a foundation component such as a screw anchor that may be used in applicant's EARTH TRUSS foundation system. The foundation component 10 is an elongated hollow shaft having an external thread form at one end and driving ring 12 and attachment features 11 at the opposite end. Component 10 may have a length ranging, for example, from one to two and a half meters. Using applicant's proprietary truss installation and assembly machine, known commercially as a TRUSS DRIVER, foundation component 10 is driven by inserting the end with the driving ring 12 into the bottom of the chuck. In various embodiments, and as shown and discussed herein, the chuck may have a series of cavities or indentations formed in it that match the geometry of the driving ring on the screw anchor to enable it to transfer torque and downforce to the upper end of the component. This is true, for example, in the embodiments shown in FIG. 1-8. As shown, the cavities or indentations may have a repeating pattern of alternating small and large voids. This enables the screw anchor to be driven so that the location of the attachment features 11 are known in at least two-dimensional space using an absolute position encoder on the rotary driver. As shown, the larger voids are correlated to the location of the holes formed in the upper end of the screw anchor that serve as the attachment features. In other words, if the machine drives a screw anchor the location of those attachment features can be precisely controlled so that an elbow or other component that attaches via those features will be pointing at the correct location in free space to enable the truss to be precisely assembled.

As mentioned herein, foundation components driven at plumb orientations in reactive and/or frost-heave prone soils may have to be longer than those in hard soils and may have to extend deeper to get to the solid soil layer and may be larger in diameter and thickness, increasing their weight relative to foundation components used in hard soils. This extra weight requires a chuck mechanism that is still relatively easy to load (e.g., requires overcoming a relatively small amount of resistance to load) but that has strong holding power once loaded.

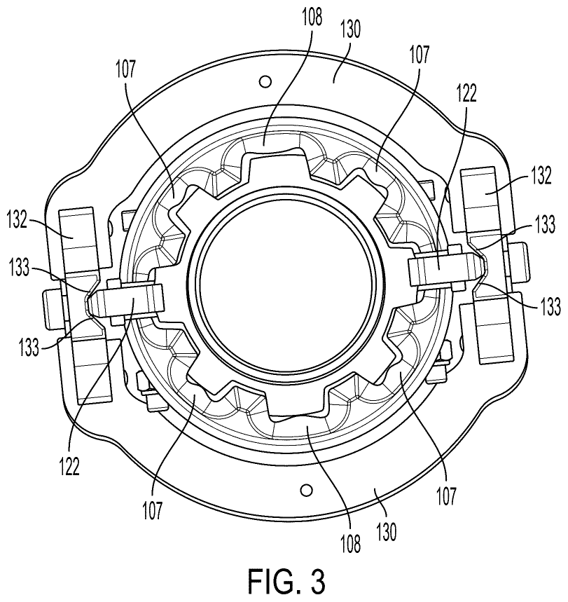

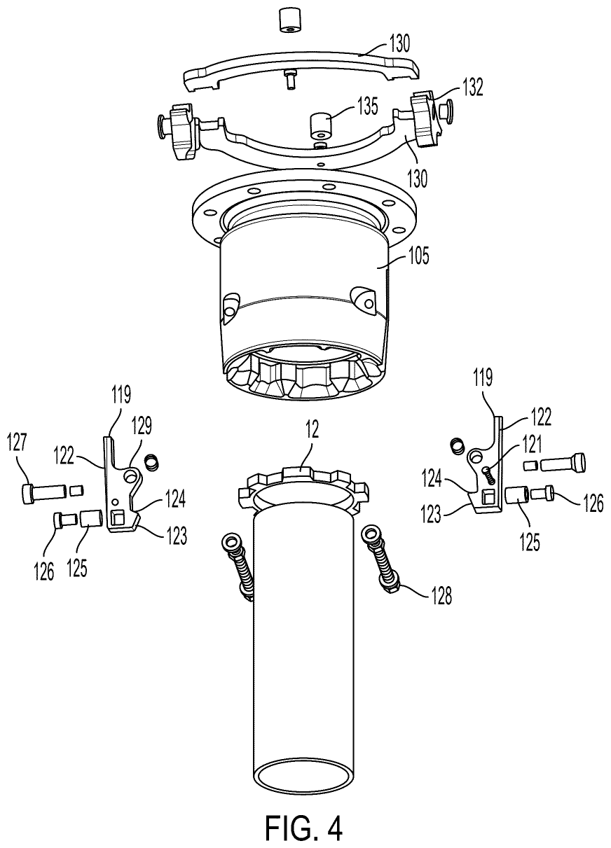

Turning now to FIGS. 1 and 2, these figures show chuck 100 with locking release mechanism 120 for a rotary driver according to various exemplary embodiments of the invention. Chuck 100 has a main body portion 105 with opening 101 at the upper end to allow a drill rod to pass through. Flange 106, as shown, has a series of holes formed in it to enable it to be mounted to the output of a rotary driver, such as the rotary driver on applicant's TRUSS DRIVER machine, with bolts, screws, or other suitable fasteners. Locking release mechanism 120 has a pair of levers 130 that are positioned on the outer surface of and curve around main body 105. Levers 130 are connected to cam 132 so that as either lever is compressed towards flange 106, cam 132 is turned. As seen in FIG. 3, when this happens, contact surfaces 133 on the inside of cam 132 push against the upper end 119 of pawls 122. Stops 135 prevent levers 130 from contacting the flange. As seen in FIG. 1 and the exploded view shown in FIG. 4, pawls 122 extend along the outside of main body 105 with adjacent contact surfaces 123 and 124 projecting into the open lower end. The open lower end of the chuck has a series of repeating indentations 107, 108 circumscribing the opening. In various embodiments, these indentations match the patten of the teeth of driving ring 12 of screw anchor 10 shown in FIG. 9. When a foundation component such as screw anchor 10 is loaded, the upper end of the component is pushed up into the chuck. As the teeth of driving ring 12 contact surface 123 of each pawl, if sufficient force is provided (e.g., 25-35 pounds), pawls 122 will push outward, pivoting about pins 128 passing through main body 105 as upper contact surface 119 pushes against springs 125, compressing them into the body. The relatively steep angle of contact surfaces 123 aligns the force from the teeth on insertion more closely to the direction of displacement that needs to occur for the teeth to clear the pawls. Once the pawls have been displaced enough to allow the teeth of drive ring 12 to enter the chuck and rest against indentations 107, 108, pawls 122 return to their relaxed position locking behind the teeth of ring 12. The teeth are held against indentations 107, 108 by contact surfaces 124 of the pawls. The less steep angle of surfaces 124 means that when downward force is applied to the screw anchor, the direction of the force by the teeth against surfaces 124 is less aligned with the direction of displacement that must occur to release the pawls as compared to the orientation of the forces when loading. This requires much greater force (e.g., 300+ pounds to release) downward force to release the foundation component. The amount of and difference between the forces required to load a component and to pull it out of the chuck will be dictated by the angle of the adjacent contact surfaces 123, 124 of the pawls. If, however, an operator pushes one of levers 130 compressing it up toward flange 121, far less force need be applied to release anchor from the pawls (e.g., 20-30 pounds). Curved contact surfaces 133 of the cam gradually engage upper end 119 of cam 122 thereby compressing springs 125 so that the pawls will displace, and the foundation component will simply fall away under the force of gravity.

The exploded view of FIG. 4 shows the exemplary implementation of the chuck and locking release mechanism according to the embodiments shown in FIGS. 1-3. Bolts 128 secure pawls 122 to main body 105. Bolts 126 hold springs 125 in place and bolts 127 secure cams 132 to the side of the main body so that cams 132 can rotate under the force of levers 130. Stop pin 121 limits the depth of penetration of contact surfaces 123, 124 into the opening at the lower end of main body 105.

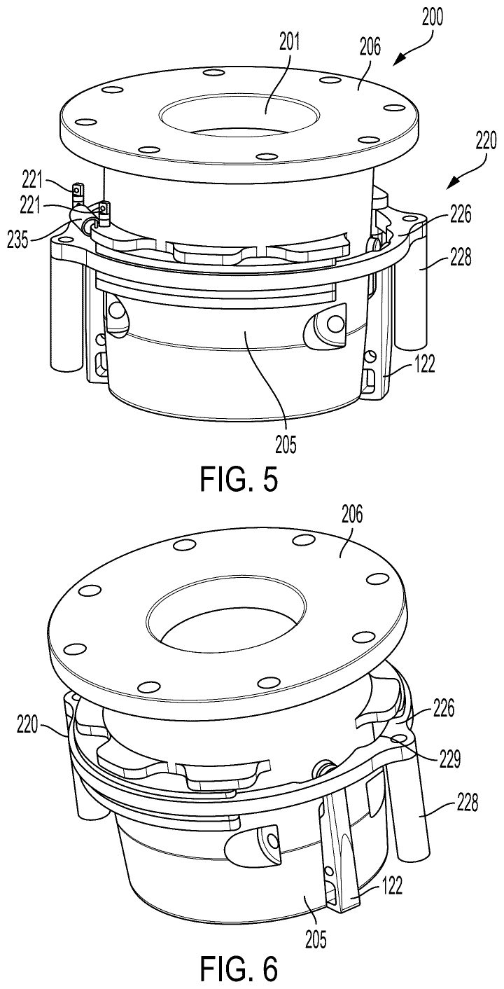

Turning now to FIGS. 5, 6, 7, and 8, these figures show locking release mechanism 220 according to various other exemplary embodiments of the invention. Rather than pushing up on a pair of levers, locking release 220 relies on a twisting force applied to a pair of handles to move the pawls holding the foundation component. Chuck 200 shown in FIGS. 5-8 has a main body 205 and flange portion 206 circumscribing a central opening 201. Ring 226 mounted on the outside surface of main body 205 has a pair of handles 228. When pressure is applied to handles 228 to rotate ring 226, ramped surface pushes against the upper end 119 of cam 122 compressing spring 125. This causes pawls 122 to bow outward at the lower ends, so that driving ring 12 of the foundation component 10 is free to fall out of indentations 207, 208. The contact surface 229 on the ring replaces the function of the cam in locking release 120. In various embodiments, pawls 122 are the same as that shown in FIGS. 1-4. When the foundation component is loaded into chuck 200, the teeth of ring 12 push against contact surfaces 123 displacing the pawls outward as the upper ends 119 compress springs 125. Once loaded, contact surfaces 124 press against the teeth of ring 12 retaining the foundation component in the chuck. In various embodiments, external spring 235 may resist the rotation of ring 226, returning it to its relaxed position when twisting force is no longer applied to handles 228. Spring 235 may be attached at either end to posts 221, one of which is fixed to the main body and the other attached to ring 226 so that spring 235 is stretched out by rotation of ring 226.

It should be appreciated that the embodiments described and claimed herein are exemplary only. Those of ordinary skill in the art will appreciate modifications and substitutions that retain the spirit and scope of the invention.

What is claimed is:

1. A chuck for a rotary driver comprising:
a main body;
a flange at a first end of the main body for engaging with a source of torque;
a receiving portion at an opposing second end of the main body having a series of repeating indentations dimensioned to receive a driving ring of a foundation component;
a pair of opposing pawls extending into the receiving portion at first ends that are displaced when a foundation component is loaded into the receiving portion, wherein the pawls are configured to resist displacement with a first force when a foundation component is loaded and resist displacement with a second force that is substantially larger than the first force when a foundation component is removed; and
a release mechanism comprising a pair of levers that move a second end of the pair of opposing pawls to release the foundation component with a force substantially smaller than the second force when one of the pair of levers is compressed towards the flange.

2. The chuck according to claim 1, further comprising a pair of springs in the main body that are compressed by a second end of the opposing pawls when they are displaced.

3. The chuck according to claim 1, wherein each pawl of the pair of opposing pawls comprises adjacent first and second contact surfaces at the first end.

4. The chuck according to claim 3, wherein the first contact surface is oriented to be relatively more orthogonal to a direction of displacement of the pawl than the second contact surface.

5. The chuck according to claim 1, further comprising a cam that is rotated by displacement of either lever of the pair of levers, the cam engaging the second end of the pair of pawls.

6. The chuck according to claim 5, the cam further comprising a second pair of contact surfaces that engage the second end of the opposing pawls when one lever of the pair of levers is compressed towards the flange.

7. A chuck for a rotary driver comprising:
a main body;
a flange at a first end of the main body for engaging with a source of torque;
a receiving portion at an opposing second end of the main body having a series of repeating indentations dimensioned to receive a driving ring of a foundation component;
a pair of opposing pawls extending into the receiving portion at first ends that are displaced when a foundation component is loaded into the receiving portion, wherein the pawls are configured to resist displacement with a first force when a foundation component is loaded and resist displacement with a second force that is substantially larger than the first force when a foundation component is removed; and
a release mechanism comprising a ring having at least one handle, wherein rotation of the ring about the main body through the application of force to the at least one handle moves the second end of the pair of opposing pawls to release the foundation component with a force substantially smaller than the second force.

8. The chuck according to claim 7, further comprising a pair of springs in the main body that are compressed by a second end of the opposing pawls when they are displaced.

9. The chuck according to claim 7, wherein each pawl of the pair of opposing pawls comprises adjacent first and second contact surfaces at the first end.

10. The chuck according to claim 9, wherein the first contact surface is oriented to be relatively more orthogonal to a direction of displacement of the pawl than the second contact surface.

11. The chuck according to claim 7, wherein the ring comprises a second pair of contact surfaces that engage the second end of the opposing pawls when the ring is partially rotated.

12. A lockable chuck for a rotary driver comprising:
a main body comprising:
a flange at a first end of the main body for engaging with a source of torque;
a receiving portion at an opposing second end of the main body, the receiving portion having a plurality of indentations configured to mate with a driving ring of a foundation component;
a pair of opposing pawls, each of the opposing pawls having:
a lever end;
a locking end opposite the lever end, wherein the locking end extends into the receiving portion when the lever end is in a locked position, and wherein the locking end does not extend within the receiving portion when the lever end is in an unlocked position; and
a release mechanism configured to urge the lever end of each of the pair of opposing pawls to the unlocked position.

13. The lockable chuck according to claim 12, further comprising a pair of springs in the main body that are compressed by a second end of the opposing pawls when they are displaced.

14. The lockable chuck according to claim 12, wherein each pawl of the pair of opposing pawls comprises adjacent first and second contact surfaces at the first end.

15. The lockable chuck according to claim 14, wherein the first contact surface is oriented to be relatively more orthogonal to a direction of displacement of the locking end of the pawl than the second contact surface.

16. The lockable chuck according to claim 12, wherein the release mechanism comprises a pair of levers.

17. The lockable chuck according to claim 16, further comprising a cam that is rotated by displacement of either lever of the pair of levers, the cam engaging the second end of the pair of pawls.

18. The lockable chuck according to claim 17, the cam further comprising a second pair of contact surfaces that engage the second end of the opposing pawls when one lever of the pair of levers is compressed towards the flange.

19. The lockable chuck according to claim 12, wherein the pawls are configured to resist displacement with a first force when a foundation component is loaded and resist displacement with a second force that is substantially larger than the first force when a foundation component is removed.

20. The lockable chuck according to claim 12, wherein each of the pair of pawls further comprises a spring configured to urge the pawl into the locked position.
